(19) United States
(12) Patent Application Publication
(10) Pub. No.: US 2025/0045796 A1
(43) Pub. Date: Feb. 6, 2025

(54) MACHINE-LEARNING ARCHITECTURE FOR DEFINING END USER AUDIENCES FOR AUTOMATED ONLINE CONTENT SELECTION

(71) Applicant: StackAdapt, Inc., Toronto (CA)

(72) Inventors: Nedialko Boyanov Dimitrov, Toronto (CA); Yahya Rafiyev, Toronto (CA); Ruize Luo, Toronto (CA)

(73) Assignee: StackAdapt, Inc., Toronto, ON (CA)

(21) Appl. No.: 18/715,555

(22) PCT Filed: Nov. 21, 2022
(86) PCT No.: PCT/CA2022/051709

§ 371 Date: May 31, 2024

Related U.S. Application Data
(60) Provisional application No. 63/284,974, filed on Dec. 1, 2021.

(51) Int. Cl. G06Q 30/0251; G06Q 30/0273

(52) U.S. Cl. CPC G06Q 30/0255; G06Q 30/0275

(57) ABSTRACT

Systems and methods described herein may determine audiences for content delivery. A server receives a context term from a client device. The server generates a set of context terms including the context term by selecting one or more of a plurality of corpus terms having a relationship with the context term. The server may calculate an implication score for each topic term of a plurality of topic terms based on a co-occurrence between the topic term and one or more of the set of context terms on a plurality of webpages associated with the topic term. The server may select a topic term from the plurality of topic terms based on the implication score for the topic term. The server may determine an audience identifying users having accessed at least one of the plurality of webpages associated with the topic term.

### TECHNICAL FIELD

This application relates generally to systems and methods for defining audiences for content selection. More specifically, it relates to allowing content providers to efficiently identify audiences with contextual relevant interests for particular types of content.

### BACKGROUND

Prior art systems allow for connecting content from content campaigns with content distributors based on a set of keywords using keyword targeting. For example, a search engine may sell ads to appear when search requests contain specified keywords. This basic method provides a relatively poor experience in which content to be distributed is often irrelevant to the search. For example, a content generator wanting to distribute information related to apple pies and bakeries may want to search for and publish their content on websites based on the keyword “apple,” yet the content could be inadvertently placed on technology or business websites discussing the tech company of the same name, Apple R, because such sites will also contain the “apple” keyword.

A second method for placing advertisements may include behavioral targeting. Under this method, a content generator (e.g., advertiser) can specify the retargeting of online advertisements to users that have been identified as having performed a conversion. Users with similar conversion characteristics (e.g., purchasing an item in the prior three months) may be grouped together. The users in the group may then be matched with a particular online content for delivery. However, with this method, the content generators are limited to selecting from only those predefined groups, and there are competing incentives between content generators and content publishers/providers, such that content publishers/providers may want to place content, articles, or other material in as many or as few groups as possible, which can overly-limit or oversaturate the delivery of the collocated content belonging to the content generator. In addition, because there are only a limited number of groupings, the content delivered to the users may be of limited relevance.

A content selection service (e.g., placement bidding service) may distribute and deliver content on behalf content creator in accordance with a content campaign in accordance with keyword targeting. Under one approach, upon detecting entry of certain terms in a search engine from a user, the service may provide content (e.g., online advertisements) to the user based on the terms. While this approach can deliver targeted content relevant to the user, the approach may rely on the user expressly entering particular keywords into the search engine. Due to the reliance on the particular search terms, this approach for keyword targeting for content delivery may be difficult to apply in circumstances where the user does not or cannot enter in terms.

### SUMMARY

What is desired is a way to provide for context and keyword targeted online content distribution without reliance on the search engine environment. The systems and methods disclosed herein are intended to address these shortcomings, but may also provide additional or alternative benefits as well. As described herein, the systems and methods may use context terms to define audiences to which to serve online content. The audience may be defined and generated by a computing device according to the user-inputted context terms: the audience may represent the users who previously accessed webpages containing topic words or phrases that are contextually relevant to the online content, and thus the users of the audience may be targeted for providing the online content when browsing webpages. These systems and methods allow an advertiser to find groups of users to which they can serve online content.

A service may collect and process online content. The service may aggregate content objects (e.g., webpages) from a content stream and processes each of the content objects into topic terms. Upon processing, the service may store the topics for each piece of content in a database. Each content object may be associated with a set of topic terms derived from the content object itself.

With the determination of the topic terms, the service may associate users with the topic terms. The service may associate users with content objects in the content stream and then use the associate to identify various topic terms to associate the user. For instance, a first user may be associated with a first content object and a second content object, while a second user may be associated with the first content object. From these associations, the service may associate the first user with the topic terms of the first content object and the second content object, and the second user with the topic terms of the first content object.

In conjunction, the service may receive in-context and out-of-context terms from a content provider via a user interface. The service may access a corpus database with a large set of terms determined (automatically by a computer or as indicated by a user input) to be related to or co-occurring with one another in the corpus. The service may identify other contextual terms that are relevant to the in-context terms and use the out-of-context terms to filter the contextual terms. With the identification of the additional context terms, the service may determine implication scores for each topic term. Based on the implication scores, the service may determine which topic terms are relevant to the context terms. For instance, the service may select the topic terms with the highest implication scores.

The service may generate content summaries for the content objects associated with the topic terms. To generate, the service may identify various phrases around the occurrence of the topic term in each associated content object. The service may apply a natural language processing model (e.g., a neural network or a knowledge graph) to determine a semantic relevance of the phrases with the topic term. If the identified phrase is determined to be relevant, the service may select the phrase to use as the content summary for the content object.

Using the topic terms, the service may determine an audience defining a set of users for the selected topic terms. The service may provide the topic terms, along with the content summaries, to the user interface of the content provider for selection. The service may identify the users associated with the selected topic terms, and may rank the users in accordance with a relevance score, such as a number of times that the users accessed the content object from which the topic terms were derived. The service may identify a subset of the users with the highest relevance scores, and may use the subset as the audience for the topic terms.

With the definition, the service may use the audience to identify opportunities to deliver online content (e.g., online advertisements, webpages, and videos) for the content provider. When a user accesses a webpage, the service may receive a request for one or more content selection parameters (e.g., bid value) to insert content onto the webpage. From the request, the service may determine that the user corresponds to one of the users defined in the audience for the content provider. Upon this determination, the service may send the content selection parameter for the content provider to a content exchange server. Using the parameter, the exchange server may run a content exchange process (e.g., a real-time bid process) to identify which content provider to select for the content to be inserted into the webpage.

In this manner, the service may allow content providers to define audiences around contextually relevant terms. The definition of the audience may allow the selection of relevant content to provide to the end-users. As a result, the end-user devices may consume less computational resources, such as processor, memory, and network bandwidth, in finding relevant content. In addition, the human-computer interaction (HCI) between the operator and the end-user device may be improved.

Aspects of the present disclosure relate to systems, methods, and non-transitory computer readable media for determining audiences for content delivery for determining users based on databases of webpage corpora for dynamic placement of content on available webpages hosted by third-party webservers. A server may receive from a client device, a context term with which to identify additional terms. The server may generate a set of context terms including the context term by selecting from a corpus database one or more of a plurality of corpus terms having a relationship with the context term, where the corpus database stores text extracted from a plurality of historic webpages. The server may calculate an implication score for each topic term of a plurality of topic terms based on a co-occurrence between each topic term and one or more of the set of context terms on a set of historical webpages associated with the topic term. The server may select a particular topic term from the plurality of topic terms based on the implication score for the particular topic term. The server may determine an audience representing a set of users having accessed at least one of the set of historic webpages associated with the topic term. The server may then store, into a campaign database, campaign data that comprises the audience representing the set of users, the set of context terms, and the particular topic terms, where the campaign data is configured for executing a real-time bidding selection operation for one or more available webpages being accessed by a user of the audience hosted by one or more third-party servers during the real-time bidding selection operation.

In some embodiments, the server may determine the plurality of topic terms from a plurality of terms on the plurality of webpages accessed by a plurality of users. In some embodiments, the server may maintain an association between each user of a plurality of users based on the user having accessed at least one of the plurality of webpages associated with the topic term. In some embodiments, the server may determine the audience using the association between each user of the plurality of users with the topic term.

In some embodiments, the server may identify a plurality of users for the topic term based on a number of times that each user of the plurality of users accessed at least one of the plurality of webpages associated with the topic term. In some embodiments, the server may identify, from a request for a selection value, an identifier for a user from the one or more users of the audience. In some embodiments, the server may transmit, to a content exchange server, the selection value of a content provider in response to identifying the identifier for the user.

In some embodiments, the server may receive, from the client device, an audience size defining a number of users to be selected from a plurality of the users for the audience. In some embodiments, the server may determine the audience identifying the one or more users from the plurality of users based on the audience size.

In some embodiments, the server may generate a plurality of phrases for the topic term using a plurality of terms on the plurality of webpages from which the topic term is determined. In some embodiments, the server may calculate the implication score based on a number of occurrences of at least one of the set of context words on at least one of the plurality of webpages associated with the topic term.

In some embodiments, the server may select a first subset of corpus terms from the plurality of corpus terms based on the context term and remove a second subset of corpus terms from the first subset of corpus terms using an out-of-context term received from the client device. In some embodiments, the server may transmit a plurality of topic terms for display on a graphical user interface (GUI) of the client device.

Both the foregoing general description and the following detailed description are examples and explanatory and are intended to provide further explanation of the invention as claimed.

### BRIEF DESCRIPTION OF THE DRAWINGS

The accompanying drawings constitute a part of this specification and illustrate an embodiment of the invention and together with the specification, explain the invention.

FIG. 1 illustrates a block diagram of a distributed computer system for determination of audiences for content delivery, in accordance with an embodiment.

FIG. 2 illustrates a flow chart of a method for determining of audiences for content delivery, in accordance with an embodiment.

FIGS. 3-4 show example webpages allowing users to determine audiences for content delivery, in accordance with an embodiment.

### DETAILED DESCRIPTION

Reference will now be made to various embodiments illustrated in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here. It should be appreciated that embodiments described herein are merely illustrative for the purposes of exemplifying the technology, technical components, and processes disclosed herein. However, some embodiments may implement aspects of the disclosed technology for other purposes or circumstances.

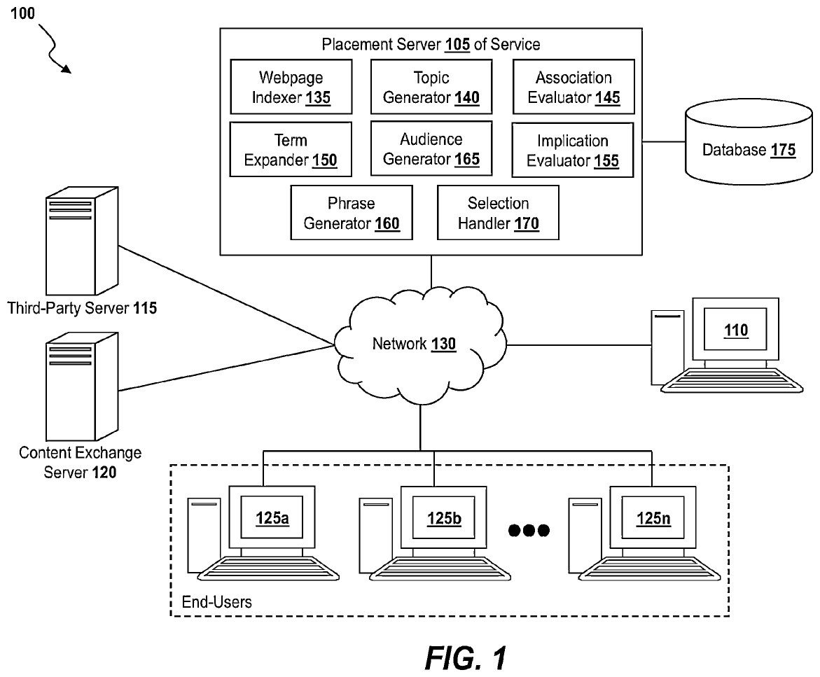

FIG. 1 depicts a block diagram of a distributed computer system 100 for determination of audiences for content delivery. The system 100 includes one or more placement servers 105 of a placement service, content provider devices 110 (sometimes herein referred to as client device) associated with a content provider preparing a content delivery campaign, third-party servers 115, content exchange servers 120 (sometimes referred to herein as real-time bidding (RTB) servers), and end-user devices 125a-125n (collectively referred to as end-user devices 125), among others, communicatively coupled with one another via one or more networks 130. The placement server 105 includes software programming defining or otherwise functioning as a webpage indexer 135, a topic generator 140, an association evaluator 145, a term expander 150, an implication evaluator 155, a phrase generator 160, an audience generator 165, and a selection handler 170. The placement server 105 includes or is in communication with a database 175. Each of the components in the system 100 may execute various software programming on one or more hardware processors coupled with memory to execute various operations. Certain components of the system 100 may be embodied in a single computing device or multiple computing devices.

The network(s) 130 includes any number of private or public networks for hosting and conducting electronic communications between electronic devices of the system 100. The network 130 may include telecommunications networks or data communications networks comprising hardware or software components for exchanging data between the devices of the system 100 in accordance with any number of telephony or networked communications.

The computing devices of the system 100 (e.g., servers, end-user devices 125, content provider devices 110) may include one or more computing devices and any type of computing device comprising hardware and software components configured to perform the various processes and tasks described herein, including one or more processors or software comprising machine-executable instructions executed by the one or more processors. Non-limiting examples of such computing devices of the system 100 include server computers, laptop computers, desktop computers, tablet computers, and smartphone mobile devices, among others. One or more servers (or other devices of the system 100), such as the placement server 105, execute webserver software for hosting one or more webpages according to web-related or data-communications protocols and computing languages.

The webpage indexer 135 executing on the placement server 105 may gather, aggregate, or retrieve webpages hosted by webserver software executed on the third-party servers 115. Each webpage is an online document in a markup language (e.g., Hypertext Markup Language (HTML)) stored or hosted by webserver software and database of the third-party server 115 and to be displayed on the end-user devices 125. In retrieving, the webpage indexer 135 may extract and download various types of data associated with each webpage. The data extracted from the webpages may include, for example, metadata, fingerprints, tags, scripts, images, text, and other content thereon. In addition, the webpage indexer 135 may retrieve or identify a page identifier (e.g., Uniform Resource Locator (URL), web address) corresponding to the webpage. Upon identification, the webpage indexer 135 may store and maintain the data extracted from the webpage onto the database 175. The webpage indexer 135 may also store and maintain an association among the data and the page identifier for the webpage onto the database 175.

The topic generator 140 executing on the placement server 105 may extract, identify, or otherwise determine a set of topic terms from the webpages of the third-party servers 115. Each topic may define or identify a semantic meaning or subject of the content in the webpage. For example, for a webpage with content containing a high number of words related to bicycles, the set of topic terms may include “bicycle.” In some embodiments, the topic generator 140 may apply a machine-learning architecture on the webpages to determine the set of topic terms for each webpage. The machine-learning architecture may include, for example, a natural language processing algorithm, an information retrieval model, a topic model, tokenization model, and a latent semantic analysis, among others. The topic generator 140 may traverse through the data extracted from the webpages indexed on the database 175. For the data from each indexed webpage, the topic generator 140 may determine the set of topic terms for each webpage from the machine-learning architecture. With the determination, the topic generator 140 may store and maintain an association between the set of topic terms and the page identifier for the webpage onto the database 175.

The association evaluator 145 executing on the placement server 105 may generate, determine, or otherwise identify an association between each end-user device 125 and the webpages. The association may identify instances that the end-user device 125 accessed the webpage. In generating, the association evaluator 145 may identify a device identifier for the end-user device 125 that accessed the webpages indexed on the database 175. For example, the webpage indexer 135 may keep track of the end-user devices 125 that accessed the webpages using a cookie on the end-user devices 125. The identifier may be a network address, such as an Internet Protocol (IP) address or a media access control (MAC) address, or a unique user identifier, such as a device identifier, an account identifier, or an identifier for advertiser (IDFA), among others. The association evaluator 145 may store and maintain an association between the data or the page identifier for the webpage, along with the device identifiers for the end-user devices 125 that accessed the webpage onto the database 175.

In addition, the association evaluator 145 may generate, determine, or otherwise identify an association between each particular end-user device 125 or user and one or more of the topic terms extracted from the webpages. The association evaluator 145 identifies the topic term derived from the webpage indexed on the database 175. For each webpage, the association evaluator 145 may also identify the each-user device 125 that accessed the webpage. Through each webpage, the association evaluator 145 may determine the association between the particular end-user device 125, the webpage, and the topic terms derived from the webpage. Based on the determination, the association evaluator 145 may store and maintain the association between the topic terms and each end-user device 125 onto the database 175.

In conjunction, the content provider device 110 may communicate and interface with the placement server 105 to define a new content delivery campaign or update a previously defined delivery campaign, including defining the audience of end-users targeted for the content delivery campaign. The content provider device 110 may detect, identify, or otherwise receive a set of inputs from a user to define the user's content delivery campaign. Using the content provider device 110, the user accesses an audience (or campaign) configuration webpage hosted by the placement server 105. The audience configuration webpage may, for example, allow the user to enter inputs configuring and defining the user's content delivery campaign.

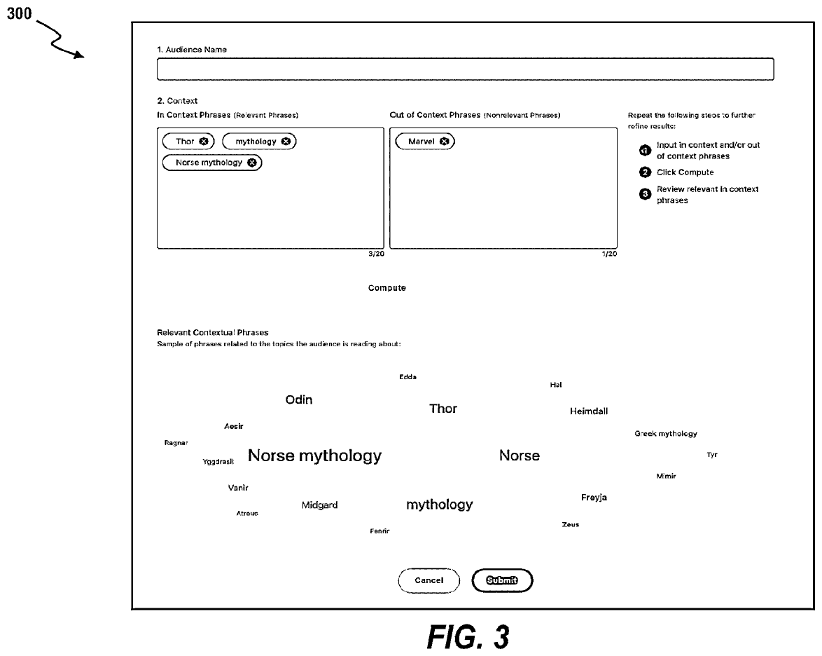

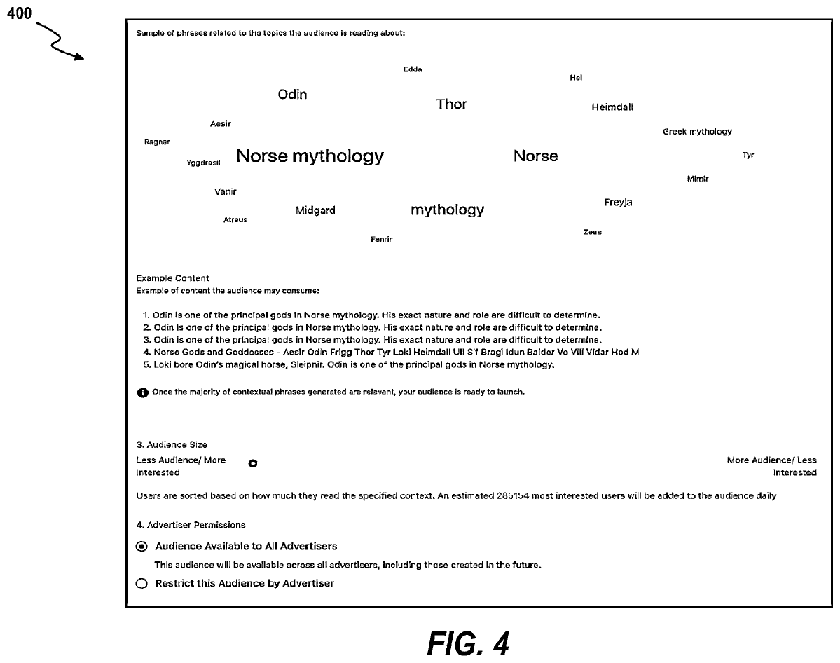

Examples of the audience configuration webpage are show in FIGS. 3-4. The inputs for defining the campaign (or audience) may indicate a set of in-context terms or phrases and a set of out-of-context terms or phrases (collectively referred to as context terms), indicating the terms or phrases that are in context or out of context with respect to the target audience of the content delivery campaign. The in-context terms indicate the words or phrases from which additional contextual terms are to be found or identified. The out-of-context terms may identify or include words or phrases used to filter or remove one or more of the additional contextual terms found using the in-context terms. For example, in FIG. 3 the in-context terms include “Thor” and the out-of-context term include “Marvel R” to find additional terms related to Norse mythology, while avoiding references to comic characters. The content provider device 110 sends the set of inputs including the in-context terms and out-of-context terms to the placement server 105.

The term expander 150 executing on the placement server 105 may initialize, train, or establish at least one machine-learning architecture to generate the additional context terms (sometimes referred to herein as beacon terms), using a corpus of documents (e.g., webpages, electronic documents) stored in an external or internal database (e.g., database 175). In general, the machine-learning architecture receives a set of inputs corresponding to the in-context and out-of-context terms, and outputs the set of additional context terms and a set of word implications (or weights) relating the inputs to the outputs. The machine-learning architecture includes any processor-executed machine-learning techniques and algorithms, such as various types of neural networks (e.g., convolutional neural networks (CNNs), deep neural networks (DNNs)), linear regression, logistic regression, k-means, k-nearest neighbors (kNN), or support vector machines (SVMs), among others. The corpus may be stored and maintained on the database 175, and may include a set of documents (e.g., webpages, articles, or other pieces of content) containing any number of potential terms and phrases. The set of documents used to train the machine-learning architecture may differ from the webpages indexed on the database 175. In some embodiments, the term expander 150 may also use additional natural language processing and vectorization machine-learning algorithms trained on the corpus maintained on the database 175.

Using the corpus, the term expander 150 trains the machine-learning architecture to calculate and determine various statistical associations among the terms, phrases, and other latent information in the corpus. The statistical associations (sometimes herein referred to as relationships) may include or identify: a probability of co-occurrence between any pair of terms or phrases among the set of documents in the corpus, a conditional likelihood (e.g., an n-gram), and a distance between the pair of terms and phrases within the set of documents, or any combination thereof, among others. To train, the term expander 150 may apply terms and phrases from the set of documents to the machine-learning architecture. By feeding the terms and phrases, the term expander 150 may process the terms and phrases using the set of weights in the machine-learning architecture to generate the additional context terms. The term expander 150 may calculate an error or loss metrics for the additional context terms by comparing to the measure derived from the set of terms in the corpus. The term expander 150 may iteratively set, adjust, or update the set of weights in the machine-learning architecture based on the loss metrics, until the machine-learning architecture reaches convergence. By adjusting the set of weights, the term expander 150 may update the machine-learning architecture to produce additional context terms reflecting the statistical association among the terms in the set of documents of the corpus on the database 175.

The term expander 150 may use the set of in-context-terms and the set of out-of-context terms received from the content provider device 110 to generate, determine, or identify additional context terms. In some embodiments, the term expander 150 may apply the machine-learning architecture to the in-context terms and out-of-context terms. In applying, the term expander 150 may feed the in-context terms and out-of-context terms as input into the machine-learning architecture. The term expander 150 may then process the input terms in accordance with the set of weights in the machine-learning architecture to generate the additional context terms. In processing, the term expander 150 may select a set of terms from the corpus having a statistical association with the in-context terms. The statistical association may satisfy a threshold amount (e.g., threshold co-occurrence) for inclusion. From the initial subset, the term expander 150 may filter, weigh less, or otherwise remove a subset of terms having a statistical association with the out-of-context terms, and may use the remaining set of terms as the additional context terms. The statistical association may also satisfy a threshold amount (e.g., threshold co-occurrence) for removal. With the generation, the term expander 150 may include the additional terms as part of the set of in-context terms to use in the audience definition.

In some embodiments, the term expander 150 may provide, transmit, or send the additional context terms to the content provider device 110. In turn, the content provider device 110 may retrieve, identify, or otherwise receive the additional context terms from the placement server 105. The content provider device 110 may present or display the additional context terms on the graphical user interface used to enter the set of in-context and out-of-context terms. The content provider device 110 may detect, identify, or receive selection of one or more of the additional context terms via the graphical user interface for defining the content delivery campaign. For example, the user on the content provider device 110 may click on a subset of the additional context terms to facilitate defining of the audience for the content delivery campaign. Upon selection, the content provider device 110 may provide, send, or transmit the selection of the additional context terms to the placement server 105.

The implication evaluator 155 executing on the placement server 105 may generate, determine, or otherwise calculate an implication score for each topic term determined from the webpages. The implication score may be based on a statistical association (e.g., co-occurrence, conditional probability, and distance) between the topic term and one or more of the set of in-context terms including the additional context terms on the webpages from which the topic term is generated. In some embodiments, the implication score for the topic term may be based on a number of occurrences of at least one of the context terms in the webpages, on which the topic term occurs. For each topic term, the implication evaluator 155 may identify the set of webpages indexed on the database 175 from which the topic term is derived. On each identified webpage, the implication evaluator 155 may determine or identify the number of occurrences of the context terms. Using the number of occurrences, the implication evaluator 155 may determine the implication score for the topic term.

Based on the implication scores for the set of topic terms, the implication evaluator 155 may identify or select one or more of the topic terms. The selection of topic terms may be used to define the audience for the content delivery campaign. In general, the higher the implication score, the more relevant the topic term may be to the context terms generated from the in-context and out-of-context terms. Conversely, the lower the implication score, the less relevant the topic term may be to the context terms generated from the in-context and out-of-context terms. In some embodiments, the implication evaluator 155 may rank the set of topic terms by the corresponding implication scores. From the ranking, the implication evaluator 155 may select N topic terms with the highest implication scores. In some embodiments, the implication evaluator 155 may compare the implication scores for the set of topic terms against a threshold score. The threshold score may define a value for the implication score at which to select the associated topic term. When the implication score for the topic term satisfies the threshold score, the implication evaluator 155 may select the topic term. Otherwise, when the implication score for the topic term does not satisfy the threshold score, the implication evaluator 155 may exclude the topic term. With the selection, the implication evaluator 155 may provide, send, or transmit the set of topic terms to the content provider device 110.

In conjunction, the phrase generator 160 executing on the placement server 105 may determine or generate a set of phrases for the topic terms using the content in the webpages indexed on the database 175. In some embodiments, the generation of the phrases may be for the topic terms selected based on the implication scores. To generate, the phrase generator 160 may identify the webpage on which the topic term occur and may identify a location of the topic term within the webpage. On each identified webpage, the phrase generator 160 may extract or identify one or more phrases with at least one term that is within a set distance (e.g., number of words) from the topic term. Upon identification, the phrase generator 160 may filter the set of phrases by applying a machine-learning architecture to determine a semantic relevance of each phrase with the topic term. The machine-learning architecture may be a natural language processing algorithm or model, such as a knowledge graph, information retrieval, automatic summarization (e.g., PEGASUS), transformer language model (e.g., Bidirectional Encoder Representations from Transformers (BERT)), and a semantic similarity network, among others. The phrase generator 160 may select one or more phrases from applying the machine-learning architecture to the phrases. Upon selection, the phrase generator 160 may provide, send, or transmit the identified phrases to the content provider device 110.

In addition, the phrase generator 160 may apply the machine-learning architecture to the extracted set of phrases to generate a set of new phrases, different form the set of phrases identified from the content in the indexed webpages. The set of new phrases may lack keywords found in the content of webpages on the database 175, and may be generated anew by applying the machine-learning architecture. In some embodiments, the phrase generator 160 may embed information from extracted set of phrases into a high-dimensional vector space for the machine-learning architecture. Using the embedding from the extracted set of phrases, the phrase generator 160 may generate the set of new phrases in accordance with the machine learning architecture. In general, the set of new phrases may contain similar information as the extracted set of phrases. For example, the phrase generator 160 may apply an abstractive summarization algorithm (e.g., PEGASUS) to the extracted set of phrases to generate the set of new phrases.

The content provider device 110 may retrieve, identify, or otherwise receive the set of topic terms from the placement server 105. The content provider device 110 may present or display the set of topic terms on the graphical user interface used to define the content delivery campaign. The topic terms may be used to define the audience for the content delivery campaign. The content provider device 110 may detect, identify, or receive a selection of the topic terms via the graphical user interface for defining the content delivery campaign. For example, the topic terms may be presented in the form of a word cloud along with the in-context terms on the graphical user interface. Using the interface, the user on the content provider device 110 may click on a subset of the topic terms to facilitate defining of the audience for the content delivery campaign. In some embodiments, the content provider device 110 may retrieve, identify, or otherwise receive the set of phrases from the placement server 105. The content provider device 110 may display or present the set of phrases on the graphical user interface. The presentation of the phrases may aid the user of the content provider device 110 in selecting the topic terms. In some embodiments, the content provider device 110 may present or display an element on the graphical user interface to define an audience size. The audience size may identify a number of end-user devices 125 to be included in the audience for the content delivery campaign. Via interaction with the element, the content provider device 110 may retrieve, identify, or receive the audience size. Upon selection, the content provider device 110 may provide, send, or transmit the selection of topic terms to the placement server 105. The content provider device 110 may also transmit the audience size to the placement server 105.

The audience generator 165 executing on the placement server 105 may generate, identify, or determine the audience for the content delivery campaign based on the topic terms. The audience may define, specify, or identify one or more end-user devices 125 to be covered by the content delivery campaign. In some embodiments, the audience generator 165 may use the topic terms selected via the content provider device 110 to determine the audience. In some embodiments, the audience generator 165 may use the set of topic terms as selected by the implication evaluator 155, without additional input from the content provider device 110. For each selected topic term, the audience generator 165 may access the database 175 to retrieve, fetch, or identify the associations between the topic term and the identifier for the end-user device 125.

In some embodiments, the audience generator 165 may identify or select a subset of the identified end-user devices 125 for the audience for the topic term. The audience generator 165 may access the database 175 to identify the webpages associated with the topic term. For each end-user device 125, the audience generator 165 may determine a topic score based on number of times that the end-user device 125 accessed the webpages associated with the topic term. The identification may be based on use of the cookie to keep track of the end-user devices 125 accessing the webpage. In some embodiments, the audience generator 165 may rank the identifier end-user devices 125 by the topic score. From the ranking, the audience generator 165 may select or identify the number of end-user devices 125 with the highest topic scores as defined by the audience size.

In some embodiments, the audience generator 165 may compare the number of accesses to a threshold. The threshold may define a value for the number of times at which to select the end-user device 125 for the audience. If the topic score satisfies the threshold, the audience generator 165 may select the end-user device 125 for the audience. Otherwise, if the topic score does not satisfy the threshold, the audience generator 165 may exclude the end-user device 125 from the audience. With the identification, the audience generator 165 may assign the identifiers for the end-user devices 125 to the audience for the topic term. With the assignment, the audience generator 165 may provide, send, or transmit the audience identifying the identifiers for the end-user devices 125 to the content provider device 110. The audience generator 165 may store and maintain the audience definition on the database 175. In some embodiments, the audience generator 165 may transmit related information, such as the topic scores in conjunction with the identifiers for the end-user devices 125.

The content provider device 110 may in turn retrieve, identify, or receive the audience definition from the placement server 105. The content provider device 110 may present or display information regarding the audience definition on the graphical user interface for defining the content delivery campaign. For example, the content provider device 110 may present the number of end-user devices 125 in the audience, topic scores, device types, and locations, among others. The content provider device 110 may detect, identify, or receive one or more inputs to adjust the audience definition, and may transmit the adjustments to the placement server 105 to repeat the above operations. The content provider device 110 may also detect or receive an interaction to initiate the content delivery campaign with the audience definition. Upon receipt, the content provider device 110 may provide, send, or transmit an indication to initiate to the placement server 105. The placement server 105 may in turn receive the indication, and initiate the content delivery campaign with the audience definition.

Subsequently, one of the end-user devices 125 may access a webpage hosted on the third-party server 115. The webpage may include an element (e.g., an inline frame) to which to insert content (e.g., online advertisement) from an entity associated with the content provider device 110. Upon reading the element, the end-user device 125 may generate a request for a selection value for inserting content into the element of the webpage. The selection value may be used by the content exchange server 120 to select content (e.g., online advertisement) from the content provider device 110 to place on a webpage accessed by the end-user device 125. The request may include an identifier for the end-user device 125, among other information. The identifier for the end-user device 125 may correspond to one of the identifiers in the definition of the audience. In some embodiments, the end-user device 125 may send the request to the content exchange server 120, and the content exchange server 120 in turn may forward the request to the placement server 105.

The selection handler 170 executing on the placement server 105 may retrieve, receive, or otherwise identify the request for the selection value from the end-user device 125. The request may be part of a part of a bid stream. The bid stream may be a data stream of published URLs available for bids to content generators interested in placing campaign content at those URLs. Upon receipt, the selection handler 170 may parse the request for the selection value to extract or identify the identifier for the end-user device 125. With the identification, the selection handler 170 may compare the identifier with the identifiers in the audience defined for the content delivery campaign of the content provider device 110.

From the comparison, the selection handler 170 may determine whether the identifier is part of the audience for the content delivery campaign of the content provider device 110. If the identifier is not part of the audience, the selection handler 170 may refrain from providing the selection value. In some embodiments, the selection handler 170 may request the content provider device 110 for the selection value, with an indication that the end-user device 125 is not part of the audience. Conversely, if the identifier is part of the audience, the selection handler 170 may retrieve, receive, or identify the selection value for the content provider device 110 associated with the audience. In some embodiments, the selection handler 170 may request the content provider device 110 for the selection value, with an indication that the end-user device 125 is part of the audience. The selection handler 170 may receive the selection value generated by the content provider device 110 for placement of content into the webpage accessed by the end-user device 125. In some embodiments, the selection handler 170 may access the database 175 to fetch, retrieve, or identify the selection value for the content provider device 110. The database 175 may store and maintain the selection value previously received from the content provider device 110. Upon identification, the selection handler 170 may provide, send, or transmit the selection value to the content exchange server 120.

The content exchange server 120 may manage competitions among content provider device 110 to compete for opportunities to deliver content on various webpages, such as the webpage accessed by the end-user device 125. The content exchange server 120 may be any third-party external web-service that publishes information (e.g., API service) and instructions (e.g., API requests) for executing various tasks described herein. Using the content selection values of the content provider devices 110, the content exchange server 120 may run a content selection process (e.g., a real time bid auction) to select one of the content provider devices 110. For example, the content exchange server 120 may select the content provider device 110 with the highest content selection value. The content exchange server 120 may send an indication of the selection to the selected content provider device 110. The content provider device 110 in turn may send, provide, or transmit the content to the element in the webpage accessed by the end-user device 125.

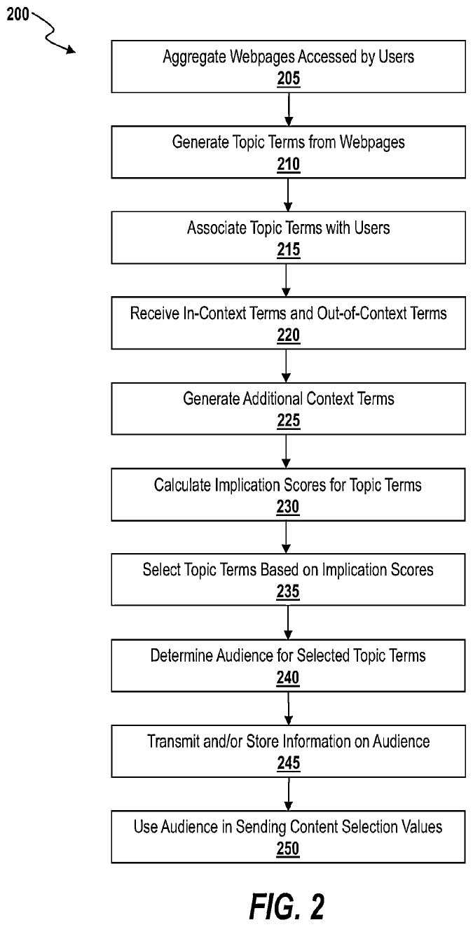

FIG. 2 depicts a flow chart of a method 200 for determining an audience of targeted end-user for content delivery. For ease of description, a server performs various operations described for the method 200, though in other embodiments, the method 200 or certain aspects of the method 200 may be performed by any number of computing devices and/or by various types of computing devices. In some embodiments, for example, the method 200 may be performed by one or more components described with respect to the system 100 of FIG. 1.

In step 205, the server aggregates webpages historically accessed by users, and in some cases user data (e.g., end-user device IP address, end-user device MAC address) for end-users having accessed these historic webpages. The server stores the historic webpages and the user data into one or more databases, such as a corpus database or end-user database. Each webpage includes an online computing file containing machine-executable code in a markup language hosted on a third-party server. The server may extract various types of data from the webpages, including text, terms, or phrases. In step 210, the server may generate topic terms from the webpages in the corpus database. Each topic term may define or identify a semantic meaning or subject of the content in the webpage. The server may apply a natural language processing algorithm to the webpages to derive the topic terms. In step 215, the server may associate topic terms with users. The server may identify the users that accessed the webpages from which the topic term is derived. With the identification, the server may associate the topic term with the users.

In step 220, the server may receive in-context terms and out-of-context terms. The in-context terms may identify or include words or phrases from which additional contextual terms are to be found or identified. The out-of-context terms may identify or include words or phrases used to filter or remove one or more of the additional contextual terms found using the in-context terms. The context terms may be entered via a graphical user interface on a client. In step 225, the server may generate additional context terms, thereby generating a set of campaign context terms comprising the in-context terms (entered by the user) and the additional context terms (dynamically generated by the server). The server may apply a machine-learning architecture to the in-context terms and the out-of-context terms to generate the additional context terms. The machine-learning architecture may be trained and established using a set of a plurality of corpus terms. The server may select a subset from the set of corpus terms related to the in-context terms. The server may then filter the initial subset using the out-of-context terms.

In step 230, the server may calculate implication scores for topic terms. For each topic term, the server may determine the implication score based on a statistical relationship between the topic term and the set of campaign context terms. The statistical relationship may be a co-occurrence or a conditional probability of the context term occurring when the topic term is present on the webpages from which the topic term is derived. In step 235, the server selects one or more particular topic terms of interest that are relevant to the campaign based on implication scores. The server may select a subset of these particular topic terms having implication scores above a threshold value.

In step 240, the server may determine an audience for the selected topic terms. The audience represents the historic end-users who accessed a historic webpage containing the subset of particular topic terms. The server may identify the webpages from which the topic term is derived and the users who accessed the webpages. The server may rank the users of the audience by, for example, the number of times that the user accessed the webpages associated with the topic term. The server may select the top number of users to assign to the audience. In step 245, the server may transmit campaign data on the audience of users generated by the server to the computing device of the content provider. Non-limiting examples of the campaign data include the audience of users, user data for the users in the audience, the in-context terms, the out-of-context terms, the set of campaign context terms, and the historic webpages containing the particular topic terms having the implication scores above the threshold value. Additionally or alternatively, the server stores the campaign data into a database (e.g., campaign database, content provider database) on behalf of the content provider for later retrieval, review, updates, or adjustments. The content provider may elect to the run the content delivery campaign using the audience definition. In step 250, the server may use the audience in sending content selection values for placement on the webpages of interest containing the subset of particular topic terms. For instance, the server may transmit bids to a RTB server, where the server may identify a bid request for a webpage of interest being accessed by a user in the audience and place a bid at the RTB server. From the request, the server may identify the user visiting the webpage of interest as part of the audience. The server may request the content provider for a bid value, and may send the bid value to the RTB server (or other content exchange server) for the real time content selection process.

FIG. 3 depicts an example webpage 300 allowing users to determine audiences for content delivery. As shown, the webpage 300 may include a graphical user interface (GUI) element to enter in-context terms (e.g., “Thor,” “mythology,” and “Norse mythology”) and out-of-context terms (e.g., “Marvel R)”) to define the audience. The webpage 300 may include another GUI graphical user element to display relevant contextual terms (e.g., “Odin,” “Aesir,” and “Ragnar,” among others) in the form of a word cloud. The relevant contextual terms may include terms relate to the in-context terms and filtered using the out-of-context terms. The webpage 300 may include another GUI element to submit the contextually relevant terms for audience definition.

FIG. 4 depicts an example webpage 400 allowing users to determine audiences for content delivery. As shown, the webpage 400 may include a GUI element to display relevant contextual terms (e.g., “Odin,” “Aesir,” and “Ragnar,” among others) generated from the in-context terms and the out-of-context terms in the form of a word cloud. The webpage 400 may include a set of content summary phrases generally below the word cloud including the contextually relevant terms. The webpage 400 may include another GUI element to define the audience size in the form of a slide ranging from “less audience/more interested” and “more audience/less interested.” The webpage 400 may include another set of GUI elements to specify the availability of the audience to various content providers (e.g., content provider devices 110).

In some embodiments, a computer-implemented method for determining users based on databases of webpage corpora for dynamic placement of content on available webpages hosted by third-party webservers. The method comprises receiving, by a server, from a client device, a context term with which to identify additional terms: generating, by the server, a set of context terms including the context term by selecting from a corpus database one or more of a plurality of corpus terms having a relationship with the context term, the corpus database storing text extracted from a plurality of historic webpages: calculating, by the server, an implication score for a plurality of topic terms based on a co-occurrence between each topic term and one or more of the set of context terms on a set of historic webpages associated with the topic term: selecting, by the server, a particular topic term from the plurality of topic terms based on the implication score for the particular topic term: determining, by the server, an audience representing a set of one or more users having accessed at least one of the set of historic webpages associated with the particular topic term; and storing, by the server into a campaign database, campaign data comprising the audience representing the set of one or more users, the set of context terms, and the particular topic term, the campaign data configured for executing a real-time bidding selection operation for an available webpage being accessed by a user of the audience hosted by one or more third-party servers during the real-time bidding selection operation.

In some implementations, the method further includes determining, by the server, the plurality of topic terms from a plurality of terms on the plurality of historic webpages accessed by a plurality of users.

In some implementations, the method further includes maintaining, by the server, an association between each user of a plurality of users based on the user having accessed at least one of the plurality of historic webpages associated with the topic term. Determining the audience further comprises identifying the set of one or more users of the audience using the association between each user of the plurality of users with the particular topic term.

In some implementations, the method further includes ranking, by the server, a plurality of users for the topic term based on a number of times that each user of the plurality of users accessed at least one of the plurality of historic webpages associated with the topic term.

In some implementations, the method further includes identifying, by the server, from a request for a selection value, an identifier for the user from the set of one or more users of the audience; and transmitting, by the server, to a content exchange server, the selection value of a content provider in response to identifying the identifier for the user.

In some implementations, the method further includes receiving, by the server, from the client device, an audience size defining a number of users to be selected from a plurality of the users for the audience. Determining the audience includes identifying the set of one or more users of the audience from a plurality of users based on the audience size.

In some implementations, the method further includes generating, by the server, a plurality of phrases for the topic term using a plurality of terms on the plurality of historic webpages from which the topic term is determined.

In some implementations, calculating the implication score further comprises calculating the implication score based on a number of occurrences of at least one of the set of context terms on at least one of the plurality of historic webpages associated with the topic term.

In some implementations, generating the set of context terms further comprises (i) selecting a first subset of corpus terms from the plurality of corpus terms based on the context term and (ii) removing a second subset of corpus terms from the first subset of corpus terms using an out-of-context term received from the client device.

In some implementations, the method further includes transmitting, by the server, the plurality of topic terms for display on a graphical user interface (GUI) of the client device.

In some embodiments, a system for determining users based on databases of webpage corpora for dynamic placement of content on available webpages hosted by third-party webservers. The system comprises non-transitory media containing one or more databases including a corpus database configured to store a plurality of historic webpages and a campaign database configured to store campaign data; and a server having at least one processor coupled with memory. The server is configured to receive, from a client device, a context term with which to identify additional terms: generate a set of context terms including the context term by selecting from text of the corpus database one or more of a plurality of corpus terms having a relationship with the context term: calculate an implication score for a plurality of topic terms based on a co-occurrence between each topic term and one or more of the set of context terms on a set of historic webpages associated with the topic term: select a particular topic term from the plurality of topic terms based on the implication score for the particular topic term: determine an audience representing a set of one or more users having accessed at least one of the set of historic webpages associated with the particular topic term; and store the campaign data into the campaign database, the campaign data configured for executing a real-time bidding selection operation for an available webpage being accessed by a user of the audience hosted by one or more third-party servers during the real-time bidding selection operation.

In some implementations, the server is further configured to determine the plurality of topic terms from a plurality of terms on the plurality of historic webpages accessed by a plurality of users.

In some implementations, the server is further configured to maintain an association between each user of a plurality of users based on the user having accessed at least one of the plurality of historic webpages associated with the topic term, and determine the audience using the association between each user of the plurality of users with the particular topic term.

In some implementations, the server is further configured to rank a plurality of users for the topic term based on a number of times that each user of the plurality of users accessed at least one of the plurality of historic webpages associated with the topic term.

In some implementations, the server is further configured to identify, from a request for a selection value, an identifier for the user from the set of one or more users of the audience; and transmit, to a content exchange server, the selection value of a content provider in response to identifying the identifier for the user.

In some implementations, the server is further configured to receive, from the client device, an audience size defining a number of users to be selected from a plurality of the users for the audience. When determining the audience, the server is further configured to identify the set of one or more users of the audience from a plurality of users based on the audience size.

In some implementations, the server is further configured to transmit the plurality of topic terms for display on a graphical user interface (GUI) of the client device.

In some embodiments, a non-transitory computer readable medium containing machine-executable program instructions. Execution of the program instructions by one or more processors of a computer system causes the one or more processors to execute the steps of: receiving, from a client device, a context term with which to identify additional terms; generating a set of context terms including the context term by selecting from a corpus database one or more of a plurality of corpus terms having a relationship with the context term, the corpus database storing text extracted from a plurality of historic webpages: calculating an implication score for a plurality of topic terms based on a co-occurrence between each topic term and one or more of the set of context terms on a set of historic webpages associated with the topic term: selecting a particular topic term from the plurality of topic terms based on the implication score for the particular topic term: determining an audience representing a set of one or more users having accessed at least one of the set of historic webpages associated with the particular topic term; and storing, into a campaign database, campaign data comprising the audience representing the set of one or more users, the set of context terms, and the particular topic term, the campaign data configured for executing a real-time bidding selection operation for an available webpage being accessed by a user of the audience hosted by one or more third-party servers during the real-time bidding selection operation.

In some implementations, the execution of the program instructions by the one or more processors of the computer system further causes the one or more processors to execute the steps of: maintaining an association between each user of a plurality of users based on the user having accessed at least one of the plurality of historic webpages associated with the topic term, and determining the audience using the association between each user of the plurality of users with the particular topic term.

In some implementations, the execution of the program instructions by the one or more processors of the computer system further causes the one or more processors to execute the steps of: identifying, from a request for a selection value, an identifier for the user from the set of one or more users of the audience; and transmitting, to a content exchange server, the selection value of a content provider in response to identifying the identifier for the user.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc. are not intended to limit the order of the steps: these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware may be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method for determining users based on databases of webpage corpora for dynamic placement of content on available webpages hosted by third-party webservers, the method comprising:
receiving, by a server, from a client device, a context term with which to identify additional terms;
generating, by the server, a set of context terms including the context term by selecting from a corpus database one or more of a plurality of corpus terms having a relationship with the context term, the corpus database storing text extracted from a plurality of historic webpages;
calculating, by the server, an implication score for a plurality of topic terms based on a co-occurrence between each topic term and one or more of the set of context terms on a set of historic webpages associated with the topic term;
selecting, by the server, a particular topic term from the plurality of topic terms based on the implication score for the particular topic term;
determining, by the server, an audience representing a set of one or more users having accessed at least one of the set of historic webpages associated with the particular topic term; and
storing, by the server into a campaign database, campaign data comprising the audience representing the set of one or more users, the set of context terms, and the particular topic term, the campaign data configured for executing a real-time bidding selection operation for an available webpage being accessed by a user of the audience hosted by one or more third-party servers during the real-time bidding selection operation.

2. The method according to claim 1, further comprising determining, by the server, the plurality of topic terms from a plurality of terms on the plurality of historic webpages accessed by a plurality of users.

3. The method according to claim 1, further comprising maintaining, by the server, an association between each user of a plurality of users based on the user having accessed at least one of the plurality of historic webpages associated with the topic term; and
wherein determining the audience further comprises identifying the set of one or more users of the audience using the association between each user of the plurality of users with the particular topic term.

4. The method according to claim 1, further comprising ranking, by the server, a plurality of users for the topic term based on a number of times that each user of the plurality of users accessed at least one of the plurality of historic webpages associated with the topic term.

5. The method according to claim 1, further comprising:
identifying, by the server, from a request for a selection value, an identifier for the user from the set of one or more users of the audience; and
transmitting, by the server, to a content exchange server, the selection value of a content provider in response to identifying the identifier for the user.

6. The method according to claim 1, further comprising receiving, by the server, from the client device, an audience size defining a number of users to be selected from a plurality of the users for the audience; and
wherein determining the audience includes identifying the set of one or more users of the audience from a plurality of users based on the audience size.

7. The method according to claim 1, further comprising generating, by the server, a plurality of phrases for the topic term using a plurality of terms on the plurality of historic webpages from which the topic term is determined.

8. The method according to claim 1, wherein calculating the implication score further comprises calculating the implication score based on a number of occurrences of at least one of the set of context terms on at least one of the plurality of historic webpages associated with the topic term.

9. The method according to claim 1, wherein generating the set of context terms further comprises (i) selecting a first subset of corpus terms from the plurality of corpus terms based on the context term and (ii) removing a second subset of corpus terms from the first subset of corpus terms using an out-of-context term received from the client device.

10. The method according to claim 1, further comprising transmitting, by the server, the plurality of topic terms for display on a graphical user interface (GUI) of the client device.

11. A system for determining users based on databases of webpage corpora for dynamic placement of content on available webpages hosted by third-party webservers, the system comprising:
non-transitory media containing one or more databases including a corpus database configured to store a plurality of historic webpages and a campaign database configured to store campaign data; and
a server having at least one processor coupled with memory, configured to:
receive, from a client device, a context term with which to identify additional terms;
generate a set of context terms including the context term by selecting from text of the corpus database one or more of a plurality of corpus terms having a relationship with the context term;
calculate an implication score for a plurality of topic terms based on a co-occurrence between each topic term and one or more of the set of context terms on a set of historic webpages associated with the topic term;
select a particular topic term from the plurality of topic terms based on the implication score for the particular topic term;
determine an audience representing a set of one or more users having accessed at least one of the set of historic webpages associated with the particular topic term; and
store the campaign data into the campaign database, the campaign data configured for executing a real-time bidding selection operation for an available webpage being accessed by a user of the audience hosted by one or more third-party servers during the real-time bidding selection operation.

12. The system according to claim 11, wherein the server is further configured to determine the plurality of topic terms from a plurality of terms on the plurality of historic webpages accessed by a plurality of users.

13. The system according to claim 11, wherein the server is further configured to:
maintain an association between each user of a plurality of users based on the user having accessed at least one of the plurality of historic webpages associated with the topic term, and
determine the audience using the association between each user of the plurality of users with the particular topic term.

14. The system according to claim 11, wherein the server is further configured to rank a plurality of users for the topic term based on a number of times that each user of the plurality of users accessed at least one of the plurality of historic webpages associated with the topic term.

15. The system according to claim 11, wherein the server is further configured to:
identify, from a request for a selection value, an identifier for the user from the set of one or more users of the audience; and
transmit, to a content exchange server, the selection value of a content provider in response to identifying the identifier for the user.

16. The system according to claim 11, wherein the server is further configured to receive, from the client device, an audience size defining a number of users to be selected from a plurality of the users for the audience; and
wherein, when determining the audience, the server is further configured to identify the set of one or more users of the audience from a plurality of users based on the audience size.

17. The system according to claim 11, wherein the server is further configured to transmit the plurality of topic terms for display on a graphical user interface (GUI) of the client device.

18. A non-transitory computer readable medium containing machine-executable program instructions, wherein execution of the program instructions by one or more processors of a computer system causes the one or more processors to execute the steps of:
receiving, from a client device, a context term with which to identify additional terms;
generating a set of context terms including the context term by selecting from a corpus database one or more of a plurality of corpus terms having a relationship with the context term, the corpus database storing text extracted from a plurality of historic webpages;
calculating an implication score for a plurality of topic terms based on a co-occurrence between each topic term and one or more of the set of context terms on a set of historic webpages associated with the topic term;
selecting a particular topic term from the plurality of topic terms based on the implication score for the particular topic term;
determining an audience representing a set of one or more users having accessed at least one of the set of historic webpages associated with the particular topic term; and
storing, into a campaign database, campaign data comprising the audience representing the set of one or more users, the set of context terms, and the particular topic term, the campaign data configured for executing a real-time bidding selection operation for an available webpage being accessed by a user of the audience hosted by one or more third-party servers during the real-time bidding selection operation.

19. The non-transitory computer readable medium according to claim 18, wherein the execution of the program instructions by the one or more processors of the computer system further causes the one or more processors to execute the steps of:
maintaining an association between each user of a plurality of users based on the user having accessed at least one of the plurality of historic webpages associated with the topic term, and
determining the audience using the association between each user of the plurality of users with the particular topic term.

20. The non-transitory computer readable medium according to claim 18, wherein the execution of the program instructions by the one or more processors of the computer system further causes the one or more processors to execute the steps of:
identifying, from a request for a selection value, an identifier for the user from the set of one or more users of the audience; and
transmitting, to a content exchange server, the selection value of a content provider in response to identifying the identifier for the user.
